(19) United States
(12) Patent Application Publication
(10) Pub. No.: US 2016/0233542 A1
(43) Pub. Date: Aug. 11, 2016

(54) ELECTROLYTIC SEPARATOR, MANUFACTURING METHOD AND SYSTEM

(71) Applicant: EXERGY HOLDING B.V., Velp (NL)

(72) Inventor: Gert Jan Jongerden, Velp (NL)

(21) Appl. No.: 15/021,517

(22) PCT Filed: Sep. 11, 2014
(86) PCT No.: PCT/NL2014/050622

§ 371 Date: Mar. 11, 2016

(30) Foreign Application Priority Data
Sep. 11, 2013 (NL) 2011422

(51) Int. Cl. H01M 10/0562; H01M 2/16; H01M 8/1246; H01M 2/14

(52) U.S. Cl. CPC H01M 10/0562; H01M 2/145; H01M 2/1646; H01M 8/1246; H01M 2008/1293

(57) ABSTRACT

An electrolytic separator, comprising a first layer (3) extending over a first side (S1) of a substrate (1), wherein the first layer (3) includes ion conducting ceramic material, characterised in that the substrate (1) includes a plurality of perforations (2) that are closed by the ion conducting ceramic material of the first layer (3).

Also, the invention provides a battery, a fuel cell, a manufacturing method and system.

The invention relates to an electrolytic separator, comprising a first layer closing perforations in a substrate, wherein the first layer includes ion conducting ceramic material.

An electrolytic separator as such is known from the prior art, and may be used e.g. to separate an anode and a cathode in a battery or fuel cell. The electrolytic separator electrically insulates the anode and cathode (i.e. prevents electron current there-through). Also, the separator is ion conducting, allowing ion exchange to take place between the anode and cathode during cell operation.

For example, U.S. Pat. No. 5,154,991 discloses a flexible separator, including a mixture of Teflon and β″-Al₂O₃. From U.S. Pat. No. 5,154,991 it follows that this separator is intended for the fabrication of sodium cells capable of high power. Manufacturing of this known separator involves sintering the entire Teflon/Al₂O₃ mixture for one hour at 280° C. under vacuum conditions. A disadvantage of this method is that the ion conductivity of the resulting separator is relatively low, thus making the separator less suitable for practical exploitation. Furthermore, the manufacturing process is relatively time- and energy consuming and the use of Teflon as a mechanical binder makes the known separator relatively expensive.

Furthermore, for lithium-ion batteries, hybrid electrolytic separators are known. For example, US2010/0291292 discloses a separator including a porous substrate of polymer fibers, carrying a porous inorganic coating, the fiber substrate having a less than 30 μm thickness, a higher than 50% porosity and a pore radius distribution, with pore radii from 75 to 150 μm. In this case, the entire porous inorganic coating layer is sintered. This separator is in general not capable of withstanding cell operating temperatures exceeding the melting temperature of the polymer fibers. Additionally, the adhesion of the inorganic coating layer to the fiber substrate is relatively poor, requiring the use of adhesion promoters. According to US2010/0291292 these promoters are selected to achieve a solidification temperature below the melting or softening temperature of the polymer substrate.

US2010/0291292 furthermore describes a process for producing a hybrid separator which is for use in lithium high power batteries and which can safely impede ionic transport beyond a shutdown temperature (120° C.). The separator comprises a flexible non-woven having a porous inorganic coating on and in the non-woven, wherein the material of the nonwoven is selected from non-woven, nonelectroconductive, polymeric fibers. The separator intentionally has a porous morphology having pores with typical dimensions in the 0.1-1 micrometer region. Such a separator is however unsuitable for use in medium to high temperature batteries in which the anode and the cathode are in a liquid state. In contrast to US 2010/0291292 therefore, in this application a fully closed separator is described.

Examples of fully closed ceramic separators are known from molten salt sodium batteries and solid oxide fuel cells. Ion conduction in these materials takes place via ion transport (e.g. hopping) processes on an atomic, (sub)nanometer scale. Such ceramic separators have been made from e.g. sintered sodium aluminium oxides so called beta- and beta″-alumina. Beta-alumina ceramics have an exceptionally high ion conductivity particularly for alkali ions, such as sodium ions. Therefore they are suitable as separator in sodium batteries. Other compounds such as NaSICON (Na Super Ionic CONductor) and ceramic microcomposite compounds consisting of beta″-alumina and zirconia grains are known as well for their high ion conductivity of sodium ions. Examples of sodium batteries are sodium-sulphur, sodium-nickel-chloride (‘ZEBRA battery’), other sodium transition metal chloride electrochemical cells and a range of other batteries. However, since beta-alumina separators are ceramic materials, they are brittle and sensitive to cracking. Therefore in the industrial development of sodium based batteries such separators are manufactured in the form of relatively thick (and sturdy) tubes with a wall thickness of at least 1 to 3 mm. To achieve sufficient ion conductivity such cells are operated at temperatures as high as 300-350° C. for sodium-sulfur cells and 250-300° C. for sodium nickel chloride cells. The manufacturing of such batteries, of the battery cells and of the separator tubes requires high annealing and sintering temperatures, long processing times and is therefore energy and capital intensive. Further, cells of such batteries are difficult to seal and thus require complex sealings, e.g. metal glass composites which need to be bonded carefully to the ceramic tubes.

WO2012/076950 relates to electrophoretic deposition of thin film batteries. 3D-TBFs are formed inside perforations (through-holes or cavities) of a substrate as well as on any remaining surface of the substrate. Each of these thin film batteries, also the batteries that extend through the perforations, includes a non-conductive separator layer. The perforations serve to increase the total surface area of the overall battery as is explained in U.S. Pat. No. 6,197,450, mentioned on page 1 of WO'950.

WO2005/057685 discloses an anode-supported solid oxide fuel cell using a cermet electrolyte. The fuel cell is provided with a porous anode. The cermet electrolyte comprises a minor metal phase dispersed throughout a ceramic material. This supported anode is not suitable for use in a molten alkali metal battery cell, since it would increase the internal cell resistance.

The present invention aims to provide an improved electrolytic separator. Particularly, the invention aims to provide a durable, strong separator that can provide relatively high ion conduction, and that can be manufactured in an economical manner. For example the present invention aims to provide an electrolytic separator with a minimal thickness, high ion conductivity and good mechanical properties, notably toughness, bendability and insensitivity to cracking. Further the invention aims to provide a separator that easily can be sealed to close compartments of a battery or fuel cell

According to the invention, the separator is characterised by the features of claim 1.

According to an aspect of the invention, a substrate including a plurality of perforations is provided that are closed by the ion conducting ceramic material.

It has been found that a resulting separator can provide a relatively high ion conductivity. Also, in various embodiments, an important advantage is that the separator can be made relatively durable and temperature resistant (e.g. withstanding continuous operating temperatures of about 130° C. or higher, dependent of the specific application).

Moreover, according to an aspect, the separator can be manufactured efficiently, in a relatively inexpensive manner, e.g. in a continuous process.

Besides, in an embodiment, a separator according to the invention allows to manufacture molten salt batteries and fuel cells with planar geometries in an industrially feasible and economically viable manner.

The ion conducting ceramic material may e.g. cover the perforations, at least partially fill the perforations, or both, to close the perforations. According to a preferred embodiment, only part of the ion conducting ceramic material sintered ceramic material; particularly, the perforations are closed by sintered ion conducting ceramic material. A resulting separator can provide relatively good durability (e.g. via the perforated carrier as well as the non-sintered parts of the ceramic material) as well as a certain desired ion conduction. In an other embodiment the ion conducting ceramic material can be entirely sintered.

More particularly, the perforations are closed by sintered ion conducting ceramic material that includes ion conducting atomic layers and channels with typical subnanometer dimensions. Such ion conducting channels may be relatively homogeneously distributed throughout the ion conducting ceramic material, as will be appreciated by the skilled person.

Particularly, each of the perforations of the substrate may extend through the substrate, without interruptions, from one side of the substrate to another side of the substrate. The perforations may be substantially, e.g. entirely, filled with the same material as the material of the first layer. Preferably, the perforations are substantially or entirely filled with the aforementioned ion conducting ceramic material. Each of the perforations may extend in a direction that is normal to the general shape of the substrate (i.e. straight through the substrate).

The perforations can be made in a well-defined manner, e.g. in a dedicated perforation manufacturing step, wherein an unperforated primary substrate is being provided with such perforations. It should be observed that the unperforated primary substrate as such may have a continuously closed first side, or a first side that already includes pores, e.g. randomly distributed pores, such as pores of a primary fiber substrate. Some of the substrate types that may be used are discussed in more detail below.

In a further embodiment, the perforations are mutually positioned in a pattern (viewed in a top view of the substrate), for example a defined pattern or a non-defined pattern. The pattern may be a non-random pattern, for example a symmetrical pattern, a partly symmetrical pattern, a line pattern, a polygonal pattern, e.g. a square, rectangular or hexagonal pattern, a close-packed pattern, a concentric pattern, or a different pattern. The pattern may be predefined, as part of a perforations manufacturing step. Besides, the predefined pattern may be a predefined random pattern (e.g. a selected random pattern, which is selected during perforation of the substrate). The perforation pattern may be selected to achieve both a durable, mechanically strong substrate as well as a relatively open substrate. In a further embodiment, the perforations have been manufactured in the substrate utilizing a substrate perforating process, for example using one or more of: drilling, etching, punching, puncturing, and ablation. Some examples of suitable perforating processes include pulsed laser etching, electrical breakdown pore generation, energy-beam ablation (e.g. using an electron-beam or ion-beam), and needle puncturing. In a further embodiment the perforations are created on purpose during the process in which the substrate is manufactured. An example of such process is the creation of a non woven fabric or a paper with the perforations created e.g. by means of a fine needle bed during the formation of the non woven fabric or paper substrate. Another example is the creation of metal fibre gauzes or of perforating and stretching metal films.

The perforations may extend in various directions with respect to the surface of the first side of the substrate. From a manufacturing point of view, advantageously, the perforations may extend in substantially the same direction through the substrate. Also, advantageously, the perforations may extend substantially normally with respect to the first side of the substrate, to provide relatively short ion conducting routes through the substrate. For example, a centre line of each of the perforations may include an angle with a normal of the first side of the substrate that is in the range of 0-30°, for example 0-15°, for example an angle of about 0°. In another embodiment, different perforations may extend in mutually different directions through the substrate.

The perforations may substantially have the same shape, viewed in cross-section, which supports efficient production of the substrate. Alternatively, perforations with different shapes may be used.

According to a further embodiment, the perforations may be relatively wide, for example having a width that is at least 1 micron, for example a width in the range of about 10 to 500 micron, for example a width in the range of about 50 to 100 micron. Also, in a further embodiment, a lateral cross-section of each of the perforations may e.g. measure at least about 1 μm², for example a cross-section in the range of about 1 μm²-1 mm², for example a range of about 1 μm²-0.1 mm², for example a range of about 1 μm²-2000 μm². Thus, relatively high ion conductivity may be achieved.

The width of some or all of the perforations may also be larger than 0.1 mm. For example, in a further embodiment, the substrate may include a number of relatively large perforations (e.g. having a width in the 1 mm² to 1 cm² range), wherein the perforations are closed by the ion conducting material, for example by closing members/elements that are made of the ion conducting material.

In a further embodiment, a ratio A1:A2 between a total perforation surface area A1 of the first side of the substrate (i.e. the part of the first side of the substrate that is open due to the perforations) and a total non-perforated surface area A2 of the first side of the substrate (i.e. the remaining part of the first side of the substrate) may be in the range of 10:90 to 90:10, for example in the range of 20:80 to 50:50.

The minimum distance between nearest-neighbour perforations of the plurality of perforations may be about the same as or larger than a tenth of a width (e.g. an average width) of those perforations, for example the same as or larger than half the width of those perforations. The resulting substrate is relatively strong. Alternatively, at least some distances between nearest-neighbour perforations of the plurality of perforations may be smaller than a tenth of a width (e.g. an average width) of those perforations.

The substrate as such may be a substantially flat, relatively thin, substrate, for example a web, web like or sheet like substrate, a substrate film, a homogeneous film, or a different thin substrate. Thus, relatively high ion conductivity may be achieved particularly if the thickness of the separator is kept very thin.

The perforated separator can include various types of substrates.

The substrate may consist of a fibre based fabric, a non woven sheet or a paper like material. The substrate may be manufactured from various materials, for example mica, paper or paperlike material, polymer films, like fluoropolymer , silicone, and/or epoxy films, fibrous material, plastic fibers (e.g. nonelectroconductive polymer fibers), high-temperature resistant organic fibers, aramid fibers, aramid paper, high-temperature resistant inorganic fibers, glass fibers, alumina fibers, carbon and carbon precursor fibers or a combination of these materials, or of one or more other materials.

Also the substrate may consist of a (coated) metal sheet or metal fibres. In case metal is employed in the substrate evidently the metal substrate is electrically insulated so that electronic conduction between the electrodes of the cell is prevented. For example, an Al foil or fabric with an insulating coating could be used.

Preferably, the substrate as such is made of electrically insulating (i.e. non-electroconductive) material. Similarly, preferably, the first layer as such is made of electrically insulating material.

According to a further embodiment, a thickness of the substrate may be about 1 mm or smaller, more particularly a thickness in the range of about 5 to 200 micron. Also, e.g., a thickness of the first layer may be about 1 mm or smaller, more particularly a thickness in the range of about 5 to 200 micron. The substrate as such may include or consist for example of a single layer or multiple layers. The substrate may be rigid, or flexible and/or elastic. In case of a flexible substrate, for example, a minimum bending radius of the substrate may be 1 m, for example 0.1 m.

Similarly, the entire separator, including at least the perforated substrate and the first layer, may be rigid, or flexible and/or elastic. In case of a flexible separator, for example, a minimum bending radius of the separator may be 1 m, for example 0.1 m. According to a further embodiment, the separator includes a second layer extending over a second side of the substrate, the second substrate side being faced away from the first substrate side, wherein the second layer includes ion conducting ceramic material. In that case, preferably, the ion conducting material of the first layer and the ion conducting material of the second layer adjoin one-another at least via the perforations of the substrate, providing ion conducting paths between the first and second layer. It follows that the substrate may be entirely embedded between the first layer and the second layer.

In a further embodiment, the ion conducting ceramic material of the first layer (and of the optional second layer) includes sintered ceramic material, providing relatively high ion conductivity there-through.

As is mentioned before, such sintered ceramic material may particularly include ion conducting channels that allow for ion transport to take place through the material.

Advantageously for the processing, the ion conducting ceramic material of the first (and optionally of the second) layer is not entirely sintered. Particularly, improved separator ion conductivity may be achieved by locally sintering the ceramic material, at the locations of and in the perforations, wherein remaining parts of the ceramic material are not sintered, or sintered to a lesser degree. Thus, the first layer may include sintered regions, having a high ion conductivity and other regions with a different ion conductivity (i.e. different from said high ion conductivity). As a result the separator has high ion conductivity in the regions where this is needed. In the other regions, not having been subjected to the sintering conditions, the separator may have superior mechanical properties, improving the structural integrity of the separator as a whole. As a result the novel separator may be a thin membrane, notably significantly thinner than the ceramic separators usually employed in prior art cells. Furthermore, the separator may be closed, preventing short circuiting, or electronic conduction between the electrodes of the cell.

Adhesion between substrate and ceramic layer is excellent and can be further supported by the use of adhesion promoters. Well known suitable adhesion promoters are silanes, such as alkoxysilanes, well known by the skilled person.

High interfacial adhesion is beneficial for good structural integrity, meaning that the separator is a closed membrane with good ion conducting properties, but without short-circuiting paths across the membrane. In one embodiment adhesion promoters are applied after the selective sintering process.

The first layer may include sintered sections having a relatively high porosity (e.g. ion conducting sections), and other sections having a lower porosity or substantially no porosity (e.g. ion non-conducting sections).

As a further, preferred, embodiment, the first layer may include first areas and second areas, wherein the first areas of the first layer include sintered, ion conducting ceramic material, wherein the second areas of the first layer include ceramic material that has not been sintered or that has been sintered to a lesser degree than the sintering of the ion conducting ceramic material of the first layer areas. Particularly, the first areas of the first layer coincide with (e.g. cover and/or partially fill) the perforations of the substrate, viewed in a top view, and preferably substantially fill those perforations. Similarly, the second areas of the first layer do not coincide with the perforations of the substrate, and may extend over unperforated substrate sections.

Preferably, the first areas of the first layer may be mutually separated by the second areas of the first layer, for example such that the first areas are mutually positioned in a defined pattern.

Also, at least a number of the first areas of the first layer may have a width that is at least about the same as a width of respective perforations that they close. In a further example, at least a number of the first areas of the first layer may have a maximum width that is at most two times a width of respective perforations that they close. At least a number of the first areas of the first layer may e.g. have a width that is at least 1 micron, for example a width in the range of about 10 to 500 micron, for example a width in the range of about 50 to 100 micron. Besides, a surface area of at least a number of the first areas of the first layer may measure at least about 1 μm², for example a surface area in the range of about 1 μm²-1 mm², for example a range of about

Moreover, a ratio A1:A2 between a total surface area A1 of the first areas and a total surface area A2 of the second areas, of the first layer, may be in the range of 10:90 to 90:10, for example in the range of 20:80 to 50:50.

The ceramic material of the first layer (and optional second layer) may include various ceramic materials, as will be appreciated by the skilled person. Also, the first layer may include other materials. For example, the first layer may include a mixture of one or more ceramic materials with one or more non-ceramic materials.

According to a further aspect, the afore-mentioned ceramic material my e.g. be selected from the group consisting of: aluminium oxides, zirconium oxides, silicon oxides, titanium oxides, tin oxides, NaSICON (sodium super-ionic conductor). From the above it follows that at least part of the ceramic material may be sintered, to provide a high ion conductivity. For example, as will be appreciated by the skilled person, sodium-aluminium oxide may be sintered to the β″-Al₂O₃ type.

According to a further embodiment, the ceramic material is mixed with a polymer, preferably a ion-conductive polymer.

Also, an aspect of the invention is provided by the features of claim 22.

Particularly, there is provided an electrolytic separator, for example a separator according to the first aspect, the separator comprising a first layer extending over a first side of a substrate, wherein the first layer includes first areas and second areas, particularly such that the first areas are mutually separated by the second areas, wherein the first areas include ion conducting ceramic material, wherein the second areas include material that has not been sintered or that has been sintered to a lesser degree than a sintering of the ceramic material of the first areas.

For example, the first areas may include sintered ceramic material having ion conducting channels that allow for ion transport to take place to provide the ion conductivity, wherein the second areas include ceramic material that does not have such ion conducting channels or substantially less ion conducting channels than the sintered ceramic material.

Particularly, the substrate as such is a porous substrate, for example a substrate having pores and/or perforations, the pores and/or perforations being at least partly filled with said ion conducting ceramic material (providing ion conductivity through the substrate). Also, according to a further embodiment, the material of the second areas may be a ceramic material, but that is not required.

The resulting separator is relatively durable and strong, can be made very thin, and can provide relatively high ion conductivity.

Also, an aspect of the invention provides a battery, including an anode, a cathode, and an electrolytic separator separating the anode and the cathode, characterised in that the electrolytic separator is a separator according to any of the preceding claims. A thickness of the anode and/or a thickness of the cathode, measured normally with respect to the first side of the separator substrate, may e.g. be substantially smaller than a width and/or length of the anode and/or cathode, respectively, for example two times smaller, particularly ten times smaller, than the width and/or length of the same. Also, the anode of the battery may include an alkali metal, for example sodium, lithium or potassium.

Besides, according to an embodiment, there is provided a fuel cell, for example a solid oxide fuel cell, including an anode, a cathode, and an electrolytic separator according to the invention, separating the anode and cathode.

For example, the fuel cell may be a hydrogen fuel cell, using hydrogen as a fuel, or a different type of fuel cell. The electrolytic separator of the fuel cell may be hydrogen ion (i.e. proton) conductive, in case of a hydrogen fuel cell. In another example, the separator of the fuel cell may be oxygen-ion conductive, particularly in the case of a solid oxide fuel cell (SOFC). In another example, the separator of the fuel cell may be carbonate-ion conductive, particularly in the case of a molten carbonate fuel cell (MCFC).

The present invention further provides a method for manufacturing an electrolytic separator, for example a separator according to one or more aspects of the invention.

The manufacturing method advantageously includes:
providing a substrate having perforations;
providing a first layer on a first side of the perforated substrate, such that the first layer closes the perforations, and preferably such that the first layer at least partly fills the perforations;

wherein the first layer includes ceramic material; and
sintering at least part of the first layer.

Thus, the above-mentioned advantages can be achieved. According to a further embodiment, only part of the first layer is sintered, the sintering particularly being accomplished at first areas of the layer, more particularly at the locations of the perforations. Thus, relatively high ion conductivity can be achieved at the sites of the perforations of the substrate. Parts of the first layer that are not sintered may provide for a strong adhesion to the substrate, and improved durability. Moreover, since only part of the first layer is sintered, sintering-related damage to the substrate may be avoided or reduced.

Furthermore, such partial sintering can be carried out efficiently and swiftly, e.g. using energy beam sintering.

Optionally, the method may include a step of application of a sealing material and/or adhesion promoter onto the first layer, e.g. after the sintering of at least part of the first layer. Such a sealing material and/or adhesion promoter may achieve filling up or strengthening any sintering-related defects, such as cracks or the-like.

Further, there is provided a system for efficiently and economically manufacturing an electrolytic separator, for example a separator according one or more aspects of the invention, the system including: p1 a perforation unit, for perforating a substrate; and
a layer deposition unit, for depositing at least a first layer on a first side of a substrate that has been perforated by the perforation unit.

The system may further include a sintering unit that is configured for locally or wholly sintering the first layer of a substrate that has been perforated by the perforation unit.

In another alternative embodiment sintering of ceramic particles takes place before ceramic material particles are covering the perforations in the substrate. In this embodiment the second areas of the first layer contains a sealing material, e.g. a polymer, for achieving a mechanical integrity of the membrane.

Further advantageous embodiments are described in the dependent claims. The invention will now be explained in more detail with reference to the drawings, depicting non-limiting examples of the invention.

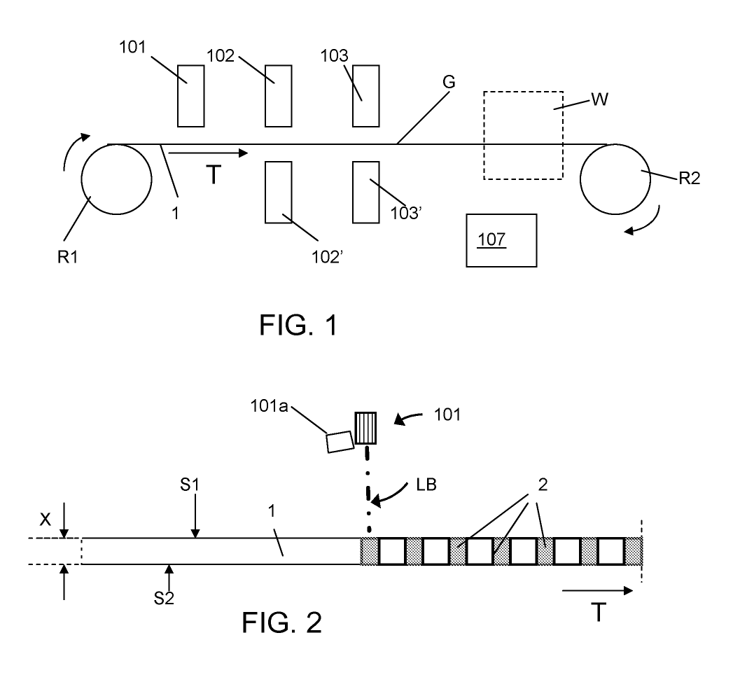

FIG. 1 schematically shows a manufacturing system according to an embodiment of the invention;

FIG. 2 schematically depicts a cross-section of a substrate part during a first manufacturing step of a method according to an embodiment of the invention;

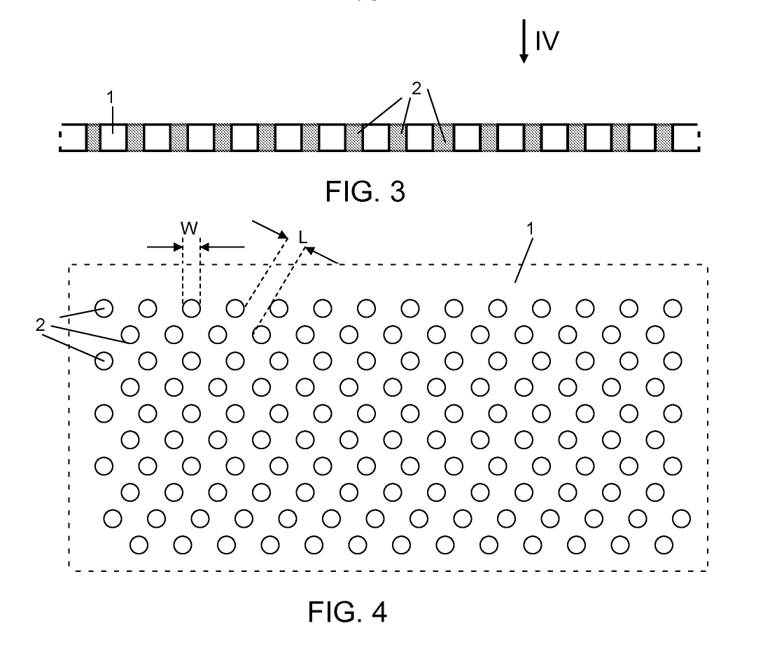

FIG. 3 schematically depicts a cross-section of the substrate part after the first manufacturing step shown in FIG. 2;

FIG. 4 schematically depicts a top view of the substrate part of FIG. 3, in a direction of arrow IV indicated in FIG. 3;

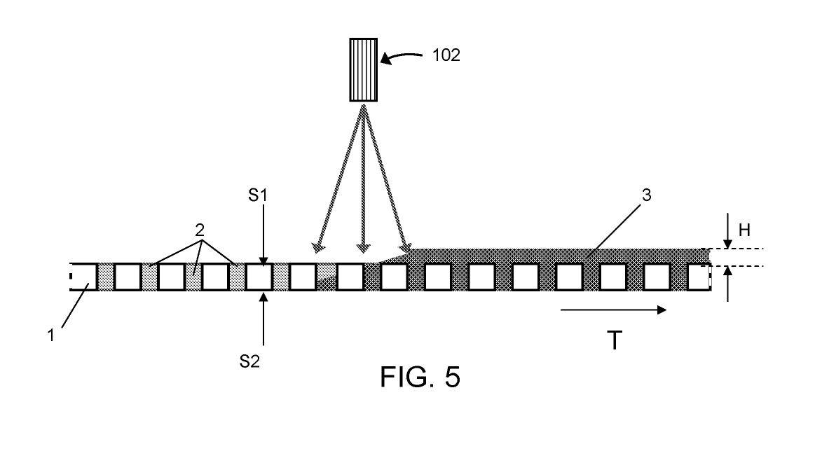

FIG. 5 schematically depicts a cross-section of a substrate part during a second manufacturing step of a method according to an embodiment of the invention;

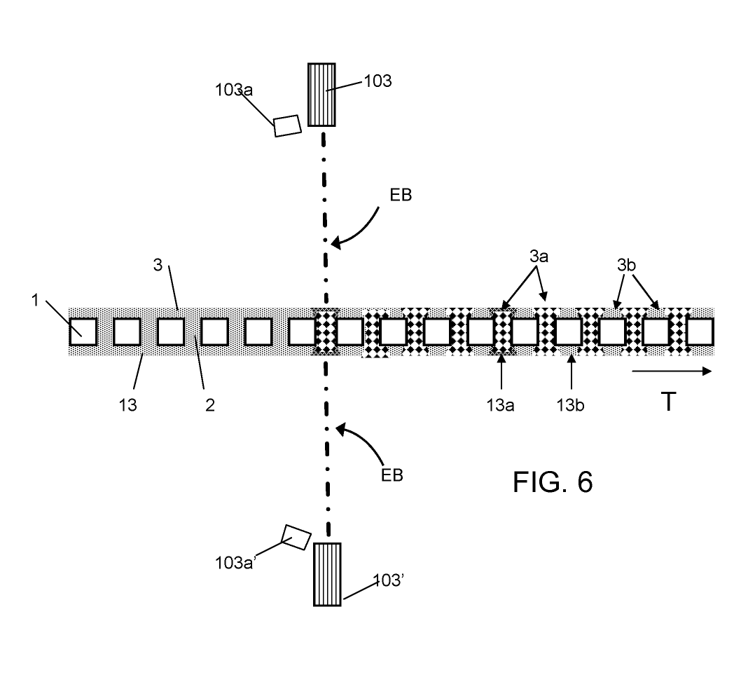

FIG. 6 schematically depicts a cross-section of a substrate part during a third manufacturing step of a method according to an embodiment of the invention; and

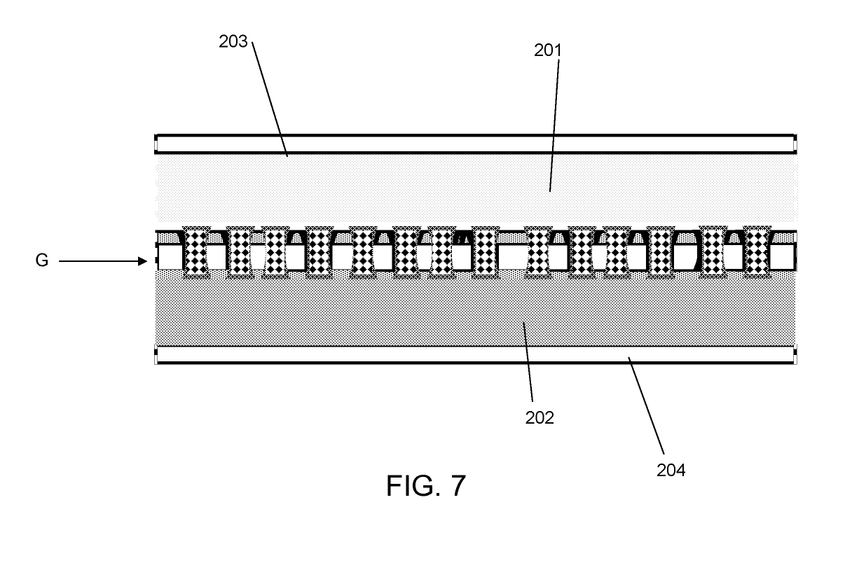

FIG. 7 depicts a part of a battery cell according to an embodiment of the invention.

Similar or corresponding features are denoted by similar or corresponding reference signs in this patent application.

FIG. 1 schematically depicts a system for manufacturing an electrolytic separator G. FIGS. 2, 5, 6 depict some components of such a system in some more detail.

The system may include a perforation unit 101 (see also FIG. 2), for perforating a substrate 1. The perforation unit 101 may be configured in various ways. As follows from the above, the perforation unit 101 may be configured to manufacture perforations 2 utilizing a substrate perforating process, for example by one or more of etching, drilling, puncturing, punching, and ablation. In the present non-limiting example, the perforation unit 101 is configured and controllable to emit an energy beam LB (see FIG. 2), for example a focussed laser beam, towards predetermined locations of the substrate 1, to locally perforate the substrate. The perforation unit 101 and substrate 1 may be movable with respect to one another during operation, for example by movement of the substrate (such as in a transporting direction T), by movement of the perforation unit 101, or both. In case of a perforation unit 101 that emits a perforating energy beam LB, the unit 101 may be configured to control the emission direction of the energy beam LB towards the substrate 1, for example by a scanning movement with respect to the first substrate side, to reach and perforate different substrate locations. The perforation unit 101 may include a positioning means, e.g. a sensor or optical detector 101a, for accurately positioning the unit 101 and substrate 1 with respect to each other.

Besides, in an embodiment, the perforation unit may be part of a substrate manufacturing system (not shown). As an example, in case of production of a fibrous or a paper or paper like substrate, e.g. a substrate of fibrous aramid paper, the perforations may be made in the substrate (e.g. by a bed of nails/thin needles or differently) before, during or just after being dried.

Particularly, the perforation unit 101 is configured to manufacture a predetermined pattern in the substrate 1. In a further embodiment, the perforating energy beam may be a pulsed energy beam, for example a pulsed laser beam. Thus, a relatively large number of perforations 2 can be manufactured swiftly and accurately, in the substrate 1.

FIGS. 3-4 depict a non-limiting example of a pattern of perforations 2 that may be made in the substrate, by the perforation unit 101. In this example, the perforations 2 all have substantially the same shape, particularly a circular shape. Also, the perforations 2 may have other shapes, e.g. elliptical, polygonal, square, hexagonal, or differently. Alternatively, perforations with different shapes may be used. Alternatively, perforations with mutually different shapes may be used in a single substrate.

Also, in this example, the perforations 2 (i.e. substrate inner sides, facing the perforations) all extend in the same direction, i.e. substantially in parallel with a normal n of the first side S1 of the substrate 1 (i.e. straight through the substrate 1). Centre lines of the perforations 2 may include an angle with a normal of the first side of the substrate that is in the range of 0-30°, for example 0-15°, for example an angle of about 0°. In another embodiment, different perforations 2 may extend in mutually different directions through the substrate. Particularly, each of the perforation 2, manufactured by the perforation unit 101, extends without interruptions, i.e. continuously, through the substrate 1.

The perforations may be mutually positioned in a predefined pattern, viewed in top view (see FIG. 4), wherein the pattern is defined by the perforation unit 101 during manufacturing. In the example, and as has been mentioned before, the pattern may be a non-random pattern, for example a symmetrical pattern, a partly symmetrical pattern, a line pattern, a polygonal pattern, e.g. a square, rectangular or hexagonal pattern, a close-packed pattern, a concentric pattern, or a different pattern. The pattern may be predefined, as part of a perforations manufacturing step. In another embodiment, the predefined pattern may be a predefined random pattern (e.g. a selected random pattern, selected during perforating the substrate).

As follows from FIG. 1, the system may further include a layer deposition unit 102 (schematically shown in FIG. 5), for depositing at least a first layer 3 on a first side S1 of the substrate 1 after the substrate has been perforated by the perforation unit 101. Particularly, the layer deposition unit 102 may be configured to deposit the first layer 3 such that the layer at least partly fills the perforations 2 of the substrate 1. The layer deposition unit 102 may include a coater (e.g. roll coater or powder coater), a sprayer, a printing unit, or differently, as will be appreciated by the skilled person. The layer deposition unit 102 may also be configured for sputtering, for chemical vapour deposition or vapour deposition, of the first layer 3 onto the perforated substrate 1. Besides, the coating may include making use of a wet slurry which is applied (coated) to the substrate 1, and compacted. In an alternative embodiment a coating includes making use of a dry powder which is coated to the substrate 1. The coated layer may be dried, heated and annealed.

Particularly, the layer deposition unit 102 may be configured to deposit a first layer 3 containing ceramic material on the first side S1 of the substrate 1. For example, the layer deposition unit 102 may be configured to apply a layer of a gel, a mixture or suspension containing ceramic material on the first side S1, after which the layer may be treated (e.g. heated, compacted, annealed or differently) to provide a resulting first layer 3. Such a resulting first layer 3 may predominantly consist of ceramic material, but that is not required. Also, in case of a powder coater deposition unit 102, a heated powder of ceramic material may be applied onto the substrate to provide a resulting first layer 3.

Besides, the layer deposition, to provide the first layer 3 on the substrate, may include a process of wetting the substrate in a coating bath, or differently.

In the present non-limiting example, the layer deposition unit has two sections, one section 102 for depositing the first layer 3 on the first substrate side S1, and another section 102′ for depositing a second layer 13 on a second side S2 of the substrate that is faced away from the first side S1. Particularly, the second layer 13, deposited by the second section 102′ of the layer deposition unit during operation, may also include ceramic material, or have the same material composition as the first layer 3.

In one embodiment, the first layer 3 and optional second layer 13 may be sintered during the deposition. As an example, a powder spray coating of the layer 3, 13 as such may inherently lead to an at least partial sintering of the layer 3, 13.

Also, the system may further include a dedicated first sintering unit 103 that is configured for locally sintering the first layer 3 of a substrate 1 that has been perforated by the perforation unit 101. In the example, there is also provided an optional second sintering unit 103′, for locally sintering the second layer 13.

The first sintering unit 103 may be configured for sintering the first layer 3 at locations of the perforations of the substrate 1. Also, the sintering unit 103 may include a detector 103a for detecting the substrate and/or for detecting at least a number of perforations of the substrate 1 (e.g. in the case that such locations are discernable via a respective relief of the first layer 3). Besides, the sintering unit 103 may include a positioning device R1, R2 for positioning the substrate 1, with respect to the sintering unit 103. The sintering unit 103 and optional positioning device R1, R2 is/are preferably controllable, for example utilizing detection results of the detector 103a, for directing sintering treatments to predetermined locations of the substrate 1, particularly to the locations of the perforations 2, and to leave remaining areas of the second layer 13 substantially untreated.

In a further embodiment, the first sintering unit 103 may be configured to emit an energy beam EB (see FIG. 6) for locally sintering the layer 3. The energy beam may be a pulsed energy beam. In a further embodiment, the sintering energy beam may be a laser beam, or an electron beam.

The optional second sintering unit 103′ may have the same configuration as the first sintering unit 103, for controlled (particularly local) sintering of the optional second layer 13. Besides, a single sintering unit can be available, for subsequently (preferably locally) sintering both layers 3, 13.

Moreover, in a further embodiment, an energy beam perforation unit, used for perforating the substrate 1 before application of the first layer 3, may be used as a sintering unit after the first layer has been applied to the substrate 1.

In a further embodiment, the system may include a control unit 107, for example a computer or controller, for controlling the various components 101, 102, 103, R1, R2 of the system. The control unit 107 may be configured to control each sintering unit 103, 103′, for locally sintering a first layer 3 (and optional second layer 13) at the locations of the perforations 2 through the substrate 1. To that aim, the control unit 107 may be provided with information regarding the location of those perforations 2, for example with a predetermined perforation pattern, as well as information regarding quality control of the material.

In this non-limiting example, as is shown in FIG. 1, the system may be configured to manufacture the separator G in an in-line process, for example utilizing a flexible substrate 1 that may be unwound from a supply roll R1. Depending on the type of substrate 1, a substrate supply can also be achieved differently, for example by a sheet feeder in case of a sheet-type substrate.

For example, the system may include a substrate supply, for example a rotatable supply roll R1, for continuous supply of a substrate 1 to the perforation unit 101 and subsequent system sections 102, 103.

Also, the system may include a separator receiver, for example a rotatable separator storage roll R2, or alternatively a sheet receiver or stacker, for receiving the separator G after manufacture. In a further embodiment, instead of a separator receiving roll R2, there may be provided a dividing (e.g. cutting) unit, dividing separator sections from a prepared separator, wherein the divided separator sections may e.g. be collected or stacked in suitable separator section storage means. Dividing separator sections from a separator that is stored on the receiving roll R2 after manufacture, is also envisaged.

The system may further include one or more transporting means (not shown) for transport of the substrate/separator between the various system components.

Also, alternatively, the system may be configured to manufacture the separator in a different, e.g. batch-type, process. Also, for example, one or more manufacturing steps may be carried out in different locations.

Use of the system may include a method for manufacturing an electrolytic separator. The method includes providing a substrate 1 having perforations 2, and providing a first layer on a first side S1 of the perforated substrate 1, such that the first layer closes (e.g. covers and/or fills) the perforations 2, wherein the first layer 3 includes ceramic material. Furthermore, the method includes sintering at least part of the first layer 3.

The substrate 1 as such may include various types of substrates, as is mentioned before. In the present drawings, a continuous or web-like substrate 1 is shown. Alternatively, the substrate 1 may be a relatively flat substrate, e.g. a platelet, or a sheet-like substrate.

The substrate 1 may be relatively thin, compared to lateral substrate dimensions. For example, a thickness X of the substrate 1 (measured normally with respect to the first side S1) may be about 1 mm or smaller, more particularly a thickness in the range of about 5 to 200 micron.

FIG. 2 shows an example of a first manufacturing step, including perforating the substrate 1 in a predetermined perforation pattern. As is mentioned before, the perforation step as such may be part of a substrate manufacturing process.

In this non-limiting example, the perforation is carried out by an energy beam perforation unit 101, for example scanning a pulsed energy beam LB over the substrate 1 for swiftly providing a large number of such perforations 2. An optional detector 101a may detect the substrate 1, may observe the perforation process and/or may detect perforations 2 after being applied in the substrate 1, for providing accurate control over the perforating process. The perforation process may be controlled by an afore-mentioned control unit 107.

FIGS. 3-4 depict the non-limiting example of the pattern of perforations 2 that may be made during the perforation step. The perforations 2 may e.g. have a width W that is at least 1 micron, for example a width W in the range of about 10 to 500 micron, for example a width in the range of about 50 to 100 micron. Also, in an embodiment, a lateral cross-section of each of the perforations 2 may e.g. measure at least about 1 μm², for example a cross-section in the range of about 1 μm²-1 mm², for example a range of about 1 μm²-0.1 mm², for example a range of about 1 μm²-2000 μm². Furthermore, a minimum distance L between nearest-neighbour perforations 2 of the plurality of perforations may be about the same as or larger than a tenth of a width W of those perforations 2, for example the same as or larger than half a width W of those perforations 2. In yet a further embodiment, said minimum distance L between nearest-neighbour perforations 2 may e.g. be at least 1 micron. Also, as is mentioned before, the perforation step may involve perforating the substrate 1 such that a ratio A1:A2 between a total perforated surface area A1 of the first side of the substrate and a total non-perforated surface area A2 of the first side of the substrate is in the range of 10:90 to 90:10, for example in the range of 20:80 to 50:50.

FIG. 5 schematically depicts a second manufacturing step, involving deposition of the first layer 3, including the ceramic material, onto the first side S1 of the perforated substrate 1. The deposition (by deposition unit 102) leads to the first layer 3 covering and filling the perforations 2, thereby closing those perforations. A thickness H of the first layer 3, extending on top of the first substrate side, may e.g. be about 1 mm or smaller, more particularly a thickness in the range of about 5 to 200 micron. Besides, there may be provided a deposition of the second layer 13, also including the ceramic material, on the second side S2 of the perforated substrate 1, such that the second layer covers the perforations 2. Then, the first layer 3 and second layer 13 adjoin one another at least at the sites of the perforations 2 through the substrate 1.

FIG. 6 depicts a third step, of locally sintering the first layer 3 and second layer 13. The sintering may lead to increase of ion conductivity of the layer 3, 13. The sintering of e.g. a beta-alumina precursor particularly leads to formation of beta-alumina crystalline regions. Large crystalline regions, and ‘good quality’ intergrain regions can be achieved this way, resulting in good overall ion conductivity.

A dedicated sintering step may be at least partly omitted in case the deposition of those layer 3, 13 as such already lead to a desired sintering of the layers 3, 13, for example in case the first layer is deposited on the substrate using a thermal deposition process, wherein the thermal deposition process achieves at least part of the sintering of the layer.

As is shown in FIG. 6, the first layer 3 may be selectively (i.e. only partly) sintered, at first areas 3a of the layer, particularly at the locations of the perforations 2. In this non-limiting example, the sintering includes directing the energy beam EB towards the first areas 3a of the first layer 3, to sinter the layer in those areas 3a. Remaining second areas 3b are preferably not treated by the energy beam, to remain substantially non-sintered, or at least sintered to a lesser degree than a sintering of the first areas 3a.

Similarly, the second layer 13 may be only partly sintered, namely being sintered only at first areas 13a of the layer, particularly at the locations of the perforations 2, by the second sintering unit 103′

Before, during and/or after the sintering step, one ore more optional detectors 103a, 103a′ may observe the sintering process, the substrate and/or the sintering energy beam EB, allowing for an accurate local sintering of the first layer 3 (and second layer 13, if available). The control unit 107 may use detection results of the one or more detectors 103a, 103a′ for directing and redirecting the beam EB towards the layer that is to be treated, for example in a treatment pattern that is the same as or coincides with the predetermined perforation pattern.

In a further embodiment, the selective sintering is carried out such (i.e. the sintering unit is controlled such) that the first areas 3a of the first layer are mutually separated by the second areas 3b of the first layer, for example such that the first areas 3a are mutually positioned in the defined pattern.

Particularly, the sintering is carried out such (i.e. the sintering unit is controlled such) that at least a number of the first areas 3a of the first layer have a width that is at least about the same as a width W of respective perforations that they close. Besides, for example, at least a number of the first areas 3a of the first layer 3 may have a maximum width that is at most two times a width W of respective perforations that they close.

The sintering may be such that at least a number of the first areas of the first layer have a width that is at least 1 micron, for example a width W in the range of about 10 to 500 micron, for example a width in the range of about 50 to 100 micron. In a further embodiment, a surface area of at least a number of the first areas 3a of the first layer 3 (for example of each of the first areas 3a) measures at least about 1 μm², for example a surface area in the range of about 1 μm²-1 mm², for example a range of about 10 μm²-0.1 mm², for example a range of about 100 μm²-0.01 mm². Moreover, good results may be achieved in the case that a ratio A1:A2 between a total surface area A1 of the first areas 3a and a total surface area A2 of the second areas 3a, of the first layer, is in the range of 10:90 to 90:10, for example in the range of 20:80 to 50:50.

Using the manufacturing method described above, a relatively durable electrolytic separator G may be produced, having good ion conductive properties. The resulting separator G (which may also be called a ‘composite membrane’) at least comprises the first layer 3 extending over the first side S1 of a substrate 1, wherein the first layer 3 includes ion conducting ceramic material, wherein the substrate 1 includes the pattern of perforations 2, covered by (and substantially filled with) the ion conducting ceramic material of the first layer 3. The separator G may be used at relatively high working temperatures, e.g. up to about 400° C., particularly in case the substrate is made of a material that remains intact at such a temperature and in case the first layer 3 (and optional second layer 13) is a ceramic layer. For example, in case of a mica substrate, a working temperature of 1000° C. might be achieved.

FIG. 7 schematically shows part of an application of the resulting separator G, in an electrochemical cell, particularly a battery. The cell may also e.g. be a fuel cell (examples of which have been mentioned before). The cell includes an anode 201, a cathode 202, and an electrolytic separator G separating the anode 201 and the cathode 202. In the example, external covering or shield layers, e.g. including conducting electrodes, 203, 204 are provided on the anode 201 and cathode 202, shielding and protecting the anode and cathode from the cell's environment. In the example, the cathode and anode extend substantially in parallel with the intermediate separator G. In a further embodiment, the entire cell may be substantially flexible, wherein for example all layers, including separator, anode, cathode, and shield layers, provide flexibility. For example, the cell may be configured to be rolled up or bended from an initially flat condition, for example to a relatively compact rolled up or wound state. In that case, according to a further embodiment, the cell may have e.g. have a minimum bending radius of 1 m, for example 0.1 m, or 1 cm.

The covering layers, e.g. electrodes (conducting layers) 203, 204, as such may be configured in various ways. For example, these layers 203, 204 may be provided by metal foils, for example aluminium foils, optionally coated e.g. with molybdenum.

For example, initially the present cell may be relatively flat. A thickness of the anode and/or a thickness of the cathode, measured normally with respect to separator G, may e.g. be substantially smaller than a width and/or length of the anode and/or cathode, respectively, for example two times smaller, particularly ten times smaller, than the width and/or length of the same.

According to a further embodiment, the anode, cathode, and external layers may be applied in an in-line process onto the separator G, for example directly after the manufacturing of the separator G itself. FIG. 1 schematically depicts a cell manufacturing unit, with a dashed box W, located downstream of the sintering units 103, the cell manufacturing unit W including electrode applicators (not shown in detail) to apply electrodes to the separator G. Alternatively, the cell may be manufactured separate/remote from the electrolytic separator manufacturing process and system.

Furthermore, as will be appreciated by the skilled person, the cell may include a number of additional layers, for example one or more encapsulating packaging layers, protection layers and the like.

In case of a battery cell, further embodiments of the invention include the anode including an alkali metal, for example sodium or lithium. The battery may also be configured differently, as will be clear to the skilled person.

In case of a sodium electrode (i.e. anode), for example, during manufacturing of the cell, the sodium may be deposited onto the separator G, to be molten to form the electrode. Preferably, the sodium electrode includes a 3-dimensional sodium retaining structure. A thickness of such a sodium electrode may be selected such that the volume of that electrode determines a capacity of the battery cell. Besides, the other electrode may be a sulfur electrode. The sulfur electrode may include a 3-dimensional sulfur containing structure, for example a carbon fiber nonwoven, such as carbon felt. Operation (i.e. charging and discharging) of a sodium-sulfur cell as such, at a relatively high operating temperature, is known to the skilled person.

Instead of sodium-sulfur cells, the above can be applied using e.g. nickel-sodium chloride (“Zebra”) electrodes, iron/sodium chloride, or transition metal-halide chlorine electrode combinations.

From the above it follows that there may be provided a (composite) ion selective conductive separator G (i.e. membrane), which may be suitable for electrochemical cells with high ion conductivity performance characteristics. In a further embodiment, a relatively tough high modulus and temperature resistant substrate 1 is partially or wholly encapsulated in a layer 3, 13 containing ceramic ion conductive material. The ion conductive layers preferably selectively conduct alkali metals (Na, K, Li) hydrogen or oxygen ions.

One of the advantages is that separator G can be manufactured and handled even when it has a very low thickness (preferably of 10 micrometer-1000 micrometer). Owing to such a low thickness, the separator G may provide a high ion conductivity, to be used e.g. in molten salt sodium battery cells which then can be used at working temperatures as low as 120-150° C. Also, preferably, the separator G has a certain flexibility making it easy to handle in practical applications. In particular, it follows that the separator G may be a relatively thin flat membrane, suitable for the manufacturing of stacked cells.

Besides, by a selective sintering of the ceramic material containing layer(s), mechanical properties of the carrier substrate 1 may be preserved while simultaneously the separator G may provide a desired high ionic conductivity.

The following presents the results of seven experiments that have been carried out regarding the present invention.

### EXAMPLE 1

For the manufacturing of a separator membrane, Alumina sheet consisting of alumina fibers is provided. By means of needle punching the sheet is perforated to form holes with an average diameter of 0.1 mm. The holes are positioned in a cubic pattern and are spaced ˜0.2 mm apart.

A slurry of beta-alumina in amyl alcohol is applied with a doctor blade in an even manner over the surface of the sheet so that the slurry covers the punched holes. The sheet with the applied slurry is carefully dried. Afterwards, it is sintered at 1600° C. A battery cell with an active surface of ˜10 cm2 is prepared with the thus fabricated separator membrane. To this aim, in a glove box, molten sodium is carefully injected in an evacuated anode compartment of the cell to be prepared using an injection syringe. At the cathode side of the membrane, a carbon felt is positioned and impregnated with molten sulfur. Immediately, a voltage of 2.7 V is measured between the anode and the cathode of the cell indicating its electrochemical functioning. The cell was closed and heated to 275° C., after which the cell was repeatedly discharged and charged.

### EXAMPLE 2

For the separator, a titanium foil of 50 micrometer thickness is provided. The foil is perforated by means of a Q-switched pulsed CO2 laser. The high-rate pulsed laser is used to form holes with an average diameter of 50 micrometer that are spaced 100 micrometer apart on average. The holes are punched in the foil so that they form a square grid.

Next a dispersion is provided in which beta-alumina and zirconia alumina particles are homogeneously dispersed in amyl alcohol. By means of electrophoresis the particles are then deposited on both sides of the perforated titanium foil until the perforations are fully covered and closed.

The foil with the alumina layer is then sintered at 1600° C. Afterwards, the foil is slowly cooled down to room temperature.

As a result of the sintering process, the titanium foil is covered with a thin beta″-alumina layer on both sides. A functioning battery cell with a sodium anode and a sulfur cathode was prepared with this membrane in the same way as described in example 1.

### EXAMPLE 3

This example is like example 2. Instead of a titanium foil a steel foil with perforations is used. An alternative sintering process is used with a maximum sintering temperature of 1500° C. A functioning cell was made with the resulting membrane.

### EXAMPLE 4

A fine wire titanium woven mesh, inherently having perforations of less than 0.1 mm in width, is used as a perforated separator substrate. The titanium mesh is treated like the perforated titanium foil as described in example 2 and a functioning cell was made with a membrane based on the titanium mesh.

### EXAMPLE 5

In this example a fine wire steel mesh is employed as perforated substrate. Sintering with a maximum temperature of 1500° C. is applied to sinter the beta″-alumina.

### EXAMPLE 6

In this example a thin non woven consisting of PET fibers with perforations in the micrometer range is used. A powder mixture prepared from sintered beta″-alumina powder with an average particle size between 50 and 100 micrometer and a PVDF resin solved in isophorone is applied on the nonwoven with a doctor blade. The impregnated nonwoven is heated to evaporate the solvent. A dense membrane is obtained in which the beta″-alumina particles are embedded such that sodium ion can be conducted well from the one to the other side of the membrane

A cell prepared with this membrane showed an open circuit voltage of 2.4 V at a temperature of ˜150° C.

### EXAMPLE 7

A titanium foil like used in example 2 is provided. Beta-alumina powder is sprayed by means of a flame spraying gun on the foil. Both sides of the foil are covered in this way. This membrane was used as cell separation membrane as described in example 1 resulting in an electrochemically active cell.

In the foregoing specification, the invention has been described with reference to specific examples of embodiments of the invention. It will, however, be evident that various modifications and changes may be made therein without departing from the broader spirit and scope of the invention as set forth in the appended claims.

In the claims, any reference signs placed between parentheses shall not be construed as limiting the claim. The word ‘comprising’ does not exclude the presence of other features or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1. An electrolytic separator, comprising a first layer extending over a first side of a substrate, wherein the first layer includes ion conducting ceramic material, and wherein the substrate includes a plurality of perforations that are closed by the ion conducting ceramic material of the first layer.

2. The electrolytic separator according to claim 1, wherein the perforations are mutually positioned in a pattern.

3. The electrolytic separator according to claim 1, wherein the perforations extend substantially normally with respect to the first side of the substrate, in a direction that is perpendicular to the first side of the substrate.

4. The electrolytic separator according to claim 1, wherein only part of the ion conducting ceramic material is sintered, and wherein the perforations are closed by sintered ion conducting ceramic material.

5. The electrolytic separator according to claim 1, wherein the perforations have a width that is at least 1 micron.

6. The electrolytic separator according to claim 1, wherein a lateral cross-section of each of the perforations measures within in a range of about 1 μm²-1 mm².

7. The electrolytic separator according to claim 1, wherein a minimum distance between nearest-neighbour perforations of the plurality of perforations is about the same as or larger than a tenth of a width of those perforations.

8. The electrolytic separator according to claim 1, wherein the perforations have substantially the same shape, viewed in cross-section.

9. The electrolytic separator according to claim 1, wherein the substrate is a perforated non-woven type substrate.

10. An electrolytic separator according to claim 1, wherein the substrate is a perforated woven type substrate.

11. The electrolytic separator according to claim 1, wherein the perforations have been manufactured in the substrate by one or more of: etching, puncturing, drilling, punching, and ablation.

12. The electrolytic separator according to e claim 1, comprising a second layer extending over a second side of the substrate, the second substrate side being faced away from the first substrate side, wherein the second layer includes ion conducting ceramic material.

13. The electrolytic separator according to claim 1, wherein a thickness of the substrate is about 1 mm or smaller.

14. The electrolytic separator according to claim 1, wherein a thickness of first layer is about 1 mm or smaller.

15. The electrolytic separator according to claim 1, wherein the first layer includes first areas and second areas, wherein the first areas of the first layer include sintered, ion conducting ceramic material, and wherein the second areas of the first layer include ceramic material that has not been sintered or that has been sintered to a lesser degree than a sintering of the ion conducting ceramic material of the first layer areas.

16. The electrolytic separator according to claim 15, wherein the first areas of the first layer are mutually separated by the second areas of the first layer.

17. The electrolytic separator according to claim 15, wherein at least a number of the first areas of the first layer have a width that is at least about the same as a width of respective perforations that they close.

18. The electrolytic separator according to claim 15, wherein at least a number of the first areas of the first layer have a maximum width that is at most two times a width of respective perforations that they close.

19. The electrolytic separator according to claim 15, wherein at least a number of the first areas of the first layer have a width that is at least 1 micron.

20. The electrolytic separator according to claim 15, wherein a surface area of at least a number of the first areas of the first layer measures within in the range of about 1 μm²-1 mm².

21. The electrolytic separator according to claim 15, wherein a ratio (A1:A2) between a total surface area A1 of the first areas and a total surface area A2 of the second areas, of the first layer, is in the range of 10:90 to 90:10.

22. The electrolytic separator according to claim 1, comprising a first layer extending over a first side of a substrate, wherein the first layer includes first areas and second areas, such that the first areas are mutually separated by the second areas, wherein the first areas include ion conducting ceramic material, and wherein the second areas include material that has not been sintered or that has been sintered to a lesser degree than a sintering of the ceramic material of the first areas.

23. A battery, including an anode, a cathode, and an electrolytic separator separating the anode and the cathode, the electrolytic separator being a separator according to claim 1.

24. The battery according to claim 23, wherein a thickness of the anode and/or a thickness of the cathode, measured normally with respect to the first side of the separator substrate, is substantially smaller than a width and/or length of the anode and/or cathode, respectively, than the width and/or length of the same.

25. The battery according to claim 23, wherein the anode of the battery includes an alkali metal.

26. A fuel cell, including an anode, a cathode, and an electrolytic separator according to claim 1, separating the anode and cathode.

27. A method for manufacturing an electrolytic separator according to claim 1, including:
providing a substrate having perforations;
providing a first layer on a first side of the perforated substrate, such that the first layer closes the perforations, wherein the first layer includes ceramic material; and
sintering at least part of the first layer.

28. The method according to claim 27, including:
providing a second layer on a second side of the perforated substrate, such that the first layer and the second layer combined close the perforations, wherein the second layer includes ceramic material; and
sintering at least part of the second layer.

29. The method according to claim 27, wherein the perforations in the substrate have been manufactured by one or more of: drilling, puncturing, etching, punching, and ablation.

30. The method according to claim 27, wherein the first layer is deposited on the substrate using a thermal deposition process, and wherein the thermal deposition process achieves at least part of the sintering of the layer.

31. The method according to claim 27, wherein the first layer is only sintered at first areas of the layer at the locations of the perforations.

32. The method according to claim 31, including directing an energy beam towards first areas of the first layer, to sinter the layer in those areas.

33. A system for manufacturing an electrolytic separator according to claim 1, the system including:
a perforation unit, for perforating a substrate; and
a layer deposition unit, for depositing at least a first layer on a first side of a substrate that has been perforated by the perforation unit.

34. The system according to claim 33, including a sintering unit that is configured for locally sintering the first layer of a substrate that has been perforated by the perforation unit.

35. The system according to claim 34, wherein the sintering unit is configured for sintering the first layer at locations of the perforations of the substrate.

36. The system according to claim 35, wherein the sintering unit includes a detector for detecting the substrate and/or for detecting at least a number of perforations of the substrate.

37. The system according to claim 35, wherein the sintering unit includes a positioning device for positioning the substrate.

38. The system according to claim 33, wherein the sintering unit is configured to emit an energy beam for locally sintering the layer.
